(19) United States
(12) Patent Application Publication
(10) Pub. No.: US 2011/0122761 A1
(43) Pub. Date: May 26, 2011

(54) KPI Driven High Availability Method and apparatus for UMTS radio access networks

(76) Inventor: Sundar Sriram, Aurora, IL (US)

(21) Appl. No.: 12/592,416

(22) Filed: Nov. 23, 2009

(51) Int. Cl. H04J 1/16; H04J 3/14

(52) U.S. Cl. 370/216; 370/242

(57) ABSTRACT

An apparatus in one example, comprising a network node that receives telecommunications network measurements where the network node calculates key performance indicator (KPI) measurements from the network measurements, and the network node performs system recovery actions based on the calculated KPI measurements.

### TECHNICAL FIELD

The invention relates generally to telecommunications network availability and more particularly to maintaining network availability in telecommunications networks using key performance indicators (KPIs).

### BACKGROUND

The field of wireless telecommunications becomes more competitive each year. As the industry matures, subscribers expect high quality and reliable service. If a service provider offers unreliable service, subscribers will change providers. Thus, it is imperative that service providers offer reliable service, and equally important that equipment vendors provide high quality and reliable equipment. Towards this goal, network equipment is regularly configured with automatic detect and automatic clear (ADAC) alarms. When a piece of equipment or software fails, a standby component takes over and the alarm automatically clears. Sometimes, however, even through the alarm clears, a problem may remain. The problem may not be large enough to cause a second alarm, but it may cause degraded subscriber service.

In an effort to monitor the quality of service subscribers receive, service providers regularly collect network measurements. For example, a service provider may collect measurements concerning the setup time for a call. Or, a service provider may collect measurements concerning the number of handovers that fail. These measurements are collected periodically and later analyzed off-line by the service provider. Analysis of the data may indicate that the network topology may have to be adjusted to improve service. Analysis may also show that an existing network problem is causing degraded service. In analyzing network data, the service provider designates key performance indicator (KPI) measurements which reflect whether or not a subscriber is receiving degraded service. Because the analysis occurs off-line well after the measurements are collected, there is nothing the service provider can do to immediately correct a problem as indicated by the KPI measurements. It would be advantageous if collected measurements could be analyzed and acted upon to immediately correct network problems indicated by the KPI measurements.

### SUMMARY

The invention in one implementation encompasses an apparatus. The apparatus comprises a network node that receives telecommunications network measurements where the network node calculates key performance indicator (KPI) measurements from the network measurements. The network node performs system recovery actions based on the calculated KPI measurements.

Another implementation of the invention encompasses an apparatus comprising a key performance indicator (KPI) compute server (KCS) that calculates KPI measurements based on telecommunications network measurements, and the KCS performs system recovery actions based on the calculated KPI measurements.

In still another implementation, the invention comprises a method. The method comprises receiving telecommunications network measurements. The method further comprises determining key performance indicator (KPI) measurements from the network performance measurements, and performing system recovery actions based on the calculated KPI measurements.

### DESCRIPTION OF THE DRAWINGS

Features of example implementations of the invention will become apparent from the description, the claims, and the accompanying drawings in which:

FIG. 1 is a representation of one implementation of an apparatus that comprises a telecommunications network where a KPI recovery server (KRS) and KPI compute server (KCS) may reside;

FIG. 2 is a representation of one embodiment depicting a KRS and KCS in a telecommunications network;

FIG. 3 is a representation of one logic flow for a KPI driven high availability method.

### DETAILED DESCRIPTION

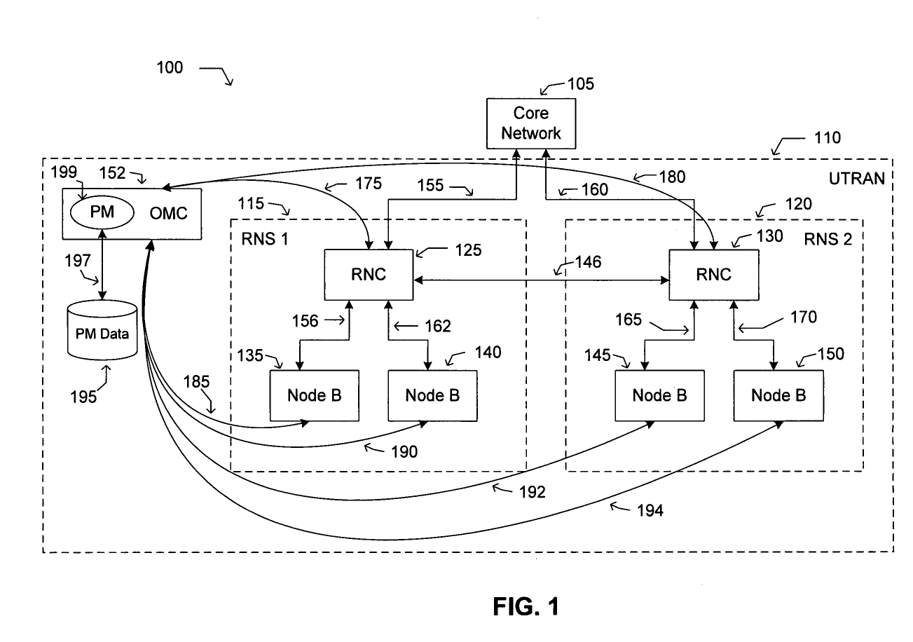

Turning to FIG. 1, an apparatus 100 in one example comprises a network where a KRS and KCS may reside. The apparatus or network 100 comprises a core network 105 and an access network or UMTS Terrestrial Radio Access Network (UTRAN) 110. The core network 105 may be an Internet Protocol (IP) network, a telephony network or any other type of network that may provide switching, routing and transit for user traffic destined and emanating from the UTRAN 110. The UTRAN 110 may provide air interface access methods for User Equipment (UE) such as mobile handsets.

The UTRAN 110 may be further divided into any number of radio network subsystems (RNS). In the embodiment depicted, UTRAN 110 is divided into two radio network subsystems (RNS) 115, 120. In other embodiments, however, there may be fewer or more RNSs. Each RNS 115, 120 may be controlled by an RNC 125, 130. In a typical UMTS network an RNC may also control a number of NodeBs. The NodeBs may provide air interface access for UEs. In the embodiment depicted, a first RNC 125 controls a first NodeB 135 and a second NodeB 140. A second RNC 130 controls a third NodeB 145 and a fourth NodeB 150. The UTRAN 110 may further comprise an Operations and Maintenance Center (OMC) 152. The OMC 152 may provision and manage the first RNC 125, the second RNC 130, the first NodeB 135, the second NodeB 140, the third NodeB 145 and the fourth NodeB 150. Still further, the OMC 152 may comprise a PM process 199 that is communicatively coupled with a performance management (PM) data store 195. The PM data store 195 may communicate with the PM process 199 over an interface 197 that is proprietary and vendor specific.

The core network 105 may be communicatively coupled with the RNCs 125, 130. The interface 155, 160 between the core network 105 and the RNCs 125, 130 may be an Iu interface or link. The Iu link 155, 160 may further comprise IuPS and IuCS links. An IuPS link may carry packet switched data from the UTRAN 110 to the core network 105, and the IuCS link may carry circuit switched data from the UTRAN 110 to the core network 105.

The RNCs 125, 130 may be communicatively coupled with the NodeBs 135, 140, 145, 150. The interfaces or links 156, 162, 165, 170 between the RNCs 125, 130 and the NodeBs 135, 140, 145, 150 may be Iub interfaces. The Iub links 156, 162, 165, 170 may comprise user voice, user data and information needed to control the air interface when a UE accesses the UTRAN 110. The RNCs 125, 130 may be communicatively coupled and communicate through an IuR interface 146.

The OMC 152 may be communicatively coupled with the first RNC 125 and the second RNC 130. The OMC 152 may communicate with the RNCs 125, 130 via an Itf-R interface or link 175, 180. The OMC 152 may also be communicatively coupled with the NodeBs 135, 140, 145, 150. The link or interface between the OMC 152 and the NodeBs 135, 140, 145, 150 may be an Itf-B link 185, 190, 192, 194. The Itf-R interfaces 175, 180 and the Itf-B interfaces 185, 190, 192, 194 may be proprietary interfaces.

During normal operations, a UE may access the UTRAN 110 via a NodeB. Data and voice may pass from the UE through the NodeB and RNC to the core network 105. For example, a subscriber using a mobile device may make a call and the call may access the network via the first NodeB 135. Data or voice involved in the call may be routed through the first NodeB 135 through the first RNC 125 and through to the core network 105. If the call is a voice call, the call may proceed over an IuCS link comprising the first Iu link 155. If the call is a data call, the call may proceed over an IuPS link comprising the first Iu link 155.

As a call is set up in the network 100 telecommunications network measurements or counts may be pegged at different elements comprising the network 100. For example, in the process of setting up a voice call, the node B 135 may peg a measurement indicating that a traffic channel was seized, and the RNC 125 may peg a measurement indicating that a call was successfully completed. As the call progresses, measurements involving handovers, signal strength and other aspects of a call in progress may be pegged at the RNC 125, 130, NodeB 135, 140, 145, 150 and other elements of the network 100. The pegged measurements may be associated with a network element, such as an RNC or NodeB. Measurements may also be associated with a network subsystem, such as a radio network subsystem (RNS) 120, or measurements may be associated with a network process running on a network element. For example, measurements may be pegged on how many successful call originations the RNS 120 supported, and a process may peg measurements associated with its memory usage.

Typically in a telecommunications network such as the network 100 depicted in FIG. 1, the OMC 152 collects measurements at regular intervals, the PM process 199 then forwards these measurements to the PM database 195 for storage. The stored measurements are examined offline to determine ways that the network 100 may be optimized. For example, the stored measurements may indicate that the RNC 125 is dropping an unacceptable number of calls. Further analysis may show that calls are being dropped because of overloading and congestion at RNC 125. That same analysis may show that RNC 130 is underutilized. The network 100 may then be reconfigured to route more traffic to RNC 130 to alleviate this problem. Other issues, such as, too many dropped handovers, over congestion in Iub interfaces 156, 162, 165, 170 or other problems encountered in the network 100 may be diagnosed and corrected through examining the measurement data stored on the PM data store 195.

As part of analyzing network statistics, a service provider or equipment vendor may designate some statistics important in indicating whether a typical subscriber is receiving good service. These important measurements may be considered key performance indicators (KPI). The vendor and service provider may agree upon the measurements that comprise KPIs. Each vendor may have a different set of measurements that the vendor considers KPIs, and what is considered a KPI may change over time. For example, a vendor may consider the setup time for a call to be a KPI. In the future, the vendor may not be as interested in call setup time, and thus the call setup time may no longer be considered a KPI. In other words, what is designated a KPI may change from time to time. This is especially true with the introduction of always-ON capabilities in SMART phones.

A KPI threshold may be associated with each KPI. The KPI threshold may indicate service that is considered acceptable. If a KPI does not meet a KPI threshold, this may indicate that the subscriber is receiving degraded service. Thus, for example, a service provider may consider dropped calls during handover to be a KPI, and the provider may set a threshold of ninety five percent success rate in handovers. If the number of dropped calls during handover exceeds five per one hundred handovers, the number of successful handovers is below the KPI threshold and thus the service is considered degraded. In another example, if the NodeB 135 is located in a busy area, the service provider may set a KPI threshold of at least five successful call originations during a busy hour. If the NodeB 135 is not providing at least five successful busy hour originations, that is an indication that the NodeB 135 is unable to provide proper service.

Another aspect of a network, such as the network 100, is that alarms are generated when components of the network 100 fail. These alarms may be displayed in a central location where an operator may act on the alarm, such as the OMC 152. In response to an alarm, the operator may reset a component of the network. For example, if an alarm is generated that indicates that a circuit board on the RNC 125 is dropping calls due to a software failure, the operator may reset or restart the software process, or the operator may reset the board.

In an effort to provide highly reliable service (99.999% and above), network equipment typically have redundant hardware and software components in a high availability configuration (Active/Standby with various flavors—Hot Standby, Warm Standby, Cold Standby). When a failure (hardware and/or software) occurs, an alarm is generated. An ADAC alarm is generated if the high availability system can automatically recover from an unplanned failure—like a card reboot or software component failure or crash. An ADMC (Automatically Detect Manually Clear) alarm is generated when the high availability system cannot automatically recover from the unplanned failure. For example, a card dies and thus cannot be restarted. In this case, the alarm will not clear until the hardware is physically replaced. Sometimes, however, the problem that lead to an ADAC alarm is not resolved even after the standby component takes over and the alarm clears. In some instances, the lingering problem leads to degraded call service that is not detected until the stored measurement data is examined at a later time. Because the stored measurement data may not be examined for a day or more, the problem of degraded call service may continue to linger for an inordinate amount of time.

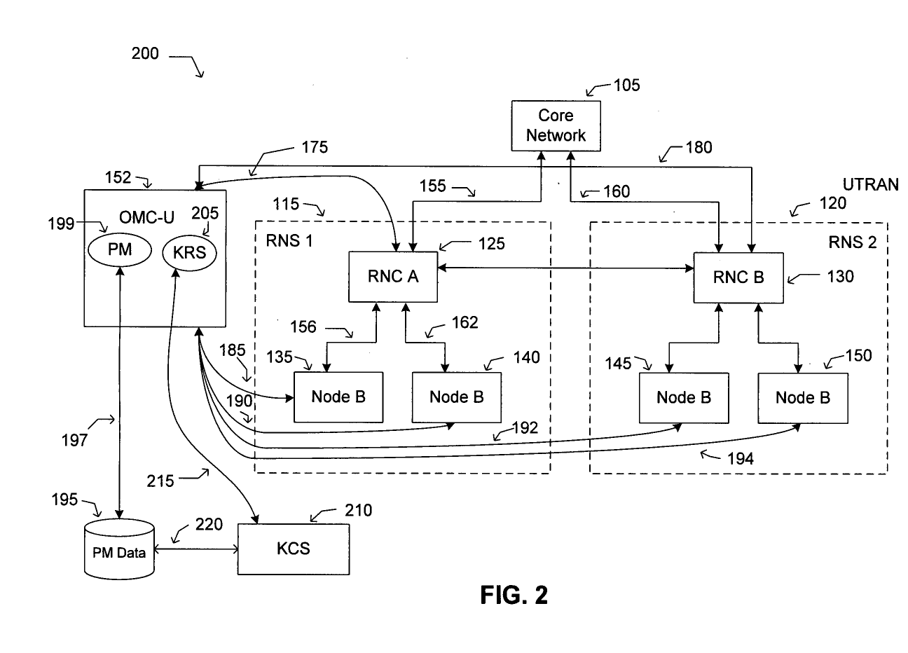

Turning now to FIG. 2, which depicts a telecommunications network 200 comprising a KRS 205 and a KCS 210. In the embodiment depicted, the KRS 205 is a process running on the OMC 152 and the KCS 210 is a separate server that is communicatively coupled with the KRS 205 via a proprietary communication link 215. The KCS 210 may also be communicatively coupled with the PM database 195 via a proprietary interface 220. In other embodiments the KCS 210 and the KRS 205 may be processes that run together on the OMC 152. In still another embodiment, the KRS 205 and the KCS 210 may be configured as processes running on a same platform separate from the OMC 152. In yet another embodiment, the KRS 205 and KCS 210 may be configured as firmware or hardware that is part of the platform comprising the OMC 152, or the KCS 210 and/or the KRS 205 may be hardware that is separate from the platform housing the OMC 152. In short, the KCS 210 and KRS 205 may be any combination of hardware, software firmware and may run on the same platform or different platforms.

In the embodiment depicted, elements comprising the network 200 may send telecommunications network measurements to the OMC 152 every fifteen minutes. The measurements may be forwarded from the OMC 152 to the PM database 195 by the PM data process 199. The KCS 210 may then aggregate or download measurements from the PM database 195 for further analysis. The KCS 210 may use the downloaded measurements to determine if any KPI thresholds are violated. If a KPI threshold is violated, the KCS 210 may determine what recovery action should be taken and communicate the recovery action to the KRS 205. The KRS 205 may then carry out the recovery action.

At the expiration of a fifteen-minute interval, elements of the network 200 may send telecommunication network measurements to the OMC 152. Thus, every fifteen minutes the RNCs 125, 130 may send measurements concerning the number of voice channels established, data channels established, packet channels established, inter-RNC handovers, intra-RNC handovers, etc. Similarly, the Node-Bs 135, 140, 145, 150 may send measurements related to the number of voice-calls originated, the number of voice-calls terminated, the number of inter-frequency handovers, the number of intra-frequency handovers, etc. Still further, measurements concerning the links 156, 162, 165, 170, 155, 160 may also be communicated to the OMC 152. Measurements may also be pegged concerning software processes and hardware components that comprise a network element. For example, the NodeB 135 may comprise a call processing (CP) process responsible for handling calls, statistics may be collected related to this process such as, call originations, call terminations and handovers. One of ordinary skill in the art will readily appreciate that this is just a sampling of the types of measurements that may be collected by the OMC 152. There are other measurements that may be collected and other elements of the network that may send measurements. Typically, a service provider and equipment vendor follow the 3rd Generation Partnership Project (3GPP) specification as pertains to the types measurements collected and how the measurements are to be collected. (left off here)

Once the telecommunications network measurements for a defined interval are collected at the OMC 152, the PM process 199 may send the measurements to the PM data store 195. The KCS 210 may aggregate or download measurements used to determine KPIs. For example, the PM data store 195 may comprise measurements associated with location updates, calls failed due to service denied, voice mail transfers and handovers as well as many other measurements. Of these measurements, handovers may be the only KPI. The KCS 210 may query the PM data store 195 and download, i.e. aggregate, statistics related to only handovers to the KCS 210. One of ordinary skill will readily appreciate that this is only example set of statistics that may be sent to the data store 195. The data store 195 may comprise hundreds of different statistics and the statistics used to compute KPIs may comprise a subset of these statistics. As described herein, a subset may be a set that is equal to or smaller than the original set. In an embodiment, the KCS 210 may analyze the aggregated KPIs to determine if any KPI thresholds are violated. For example, the PM data store 195 may contain statistics related to handovers collected at NodeB 135. There may be measurements related to successful handovers and failed handovers that occurred at NodeB 135. The failed handovers may be further broken down into inter-frequency and intra-frequency handovers. The inter-frequency handover may be further broken down into inter-frequency hard handovers and inter-frequency soft handovers. Although many different measurements may be tracked concerning handovers, a particular operator may designate only inter-frequency failed handovers as a KPI. Thus the KCS 210 may aggregate the number of failed inter-frequency handovers while the other measurements concerning handovers may be disregarded by the KCS 210. If the number of failed inter-frequency handovers exceeds a KPI threshold, the KCS 210 may communicate a recovery action to the KRS 205 that the KRS 205 may execute. In other examples, an operator may consider intra-frequency handover failures a KPI, thus the KCS 210 would aggregate statistics concerning intra-frequency handover failures. Any number of measurements may be considered a KPI, and each measured KPI may be associated with a KPI threshold.

In other examples, a KPI may be based on more than one telecommunications network measurement. For example, measurements may be taken regarding successful call completions and a number of channels allocated at NodeB 135. A KPI threshold may be set such that the number of channels allocated divided by the number of successful call completions must be less than 1.2. If this quotient is greater than 1.2, the KPI threshold is violated and an associated recovery action may be executed. In another example, the number of dropped calls at NodeB 135 divided by the number of successful call handovers measured at NodeB 135 may have to exceed one to satisfy a KPI threshold. If this quotient is less than one, the KPI threshold is violated and an associated recovery action may be executed. It should be readily apparent that a KPI threshold may be determined by combining and computing any number of measurements. Still further, other variables may be added to the computation of measurements that comprise a KPI threshold. As can be seen by these examples, a KPI threshold may be configured such that the threshold is violated if it is exceeded, or the threshold may configured such that the threshold is violated if it is not met. Regardless of how the KPI threshold is configured, a recovery action may be associated with a KPI threshold when it is violated.

If the KCS 210 determines that a KPI threshold is violated, the KCS 210 may communicate a recovery action that the KRS 205 may execute. The communication may occur over the proprietary link 215 using a proprietary protocol. An operator or equipment vendor may configure the KCS 210 to request different recovery actions based on which KPI threshold is violated. For example, a KPI threshold related to a ratio of successful call establishments recognized by the NodeB 135 and the RNC 125 may indicate that the link 156 is down or out of service. Thus the KCS 210 may communicate a message to the KRS 205 indicating that the link 156 should be reset. The KRS 205 may then reset the link 156. In other embodiments the KCS 210 may send a message to the KRS 205 indicating that other actions, such as an interface board on the RNC 125 needs to be reset. The KRS 205 may communicate the recovery actions to the NodeBs 135, 140, 145, 150 using the Itf-B links 185, 190, 192, 194, and recovery actions may be communicated to the RNCs 125, 130 using Itf-R interfaces 175, 180.

The KCS 210 may comprise a user interface so that an operator or equipment vendor may configure the KCS 210 with various configuration information, such as, KPIs, KPI thresholds and actions associated with the violation of a KPI threshold. In another embodiment, the KCS 210 may be configured so that a service provider or equipment vendor may be able to load files comprising KPI configuration information onto the KCS 210.

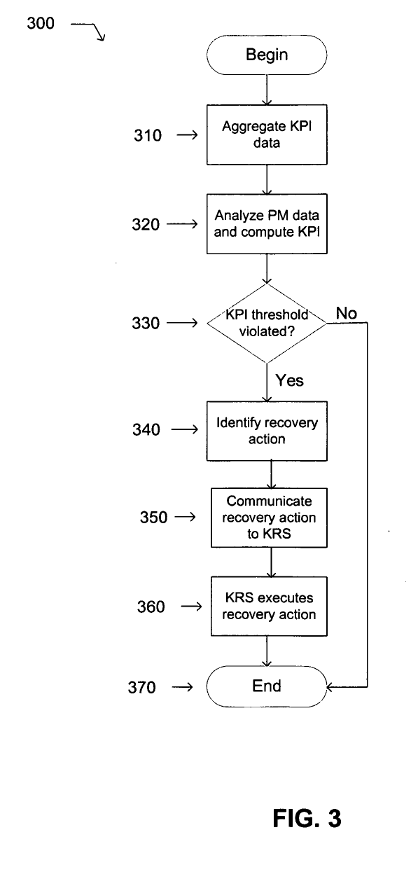

Turning now to FIG. 3, which depicts a representation of a method 300 for a KPI driven high availability apparatus as depicted in FIG. 2. In an embodiment, the method 300 may reside on the KCS 210. In other embodiments, the method 300 may reside on other network equipment. The method 300 may be invoked at defined time intervals, such as every fifteen minutes. Alternatively, the method 300 may be invoked each time new telecommunications network measurements arrive at the PM data store 195, or a service provider may manually invoke the method 300. At step 310, measurements of the PM data store 195 are aggregated, and the measurements used to compute KPIs are sent to the KCS 210. The data may comprise various measurements pegged in the network 200. The measurements may have been collected by the OMC 152 and forwarded to the PM data store 195 by the PM process 199. The KCS 210 may perform the aggregation. As discussed, a network operator or system vendor may configure the KCS 210 to compute any number of different KPIs.

At 320, the PM data, i.e. the telecommunications network measurements, are analyzed and KPIs are computed. The method 300 then determines if any KPI thresholds are violated 330. If no KPIs are violated, the method 300 ends 370. If a KPI threshold is violated, the KCS 210 determines a recovery action to take 340. Once the method 300 determines the recovery action to take 340, the method 300 communicates the recovery action 350 to the KRS 205. This communication 350 may be a message that indicates a recovery action that the KRS executes 360. As previously described, the recovery action may involve managing nodes, links, processes or any other entities comprising the network 200.

The apparatus 199, 205, 210 in one example comprises a plurality of components such as one or more of electronic components, hardware components, and computer software components. A number of such components can be combined or divided in the apparatus 199, 205, 210. An example component of the apparatus 199, 205, 210 employs and/or comprises a set and/or series of computer instructions written in or implemented with any of a number of programming languages, as will be appreciated by those skilled in the art.

The apparatus 199, 205, 210 in one example employs one or more computer-readable signal-bearing media. The computer-readable signal-bearing media store software, firmware and/or assembly language for performing one or more portions of one or more implementations of the invention. The computer-readable signal-bearing medium for the apparatus 199, 205, 210 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a network node that receives telecommunications network measurements where the network node calculates key performance indicator (KPI) measurements from the telecommunications network measurements; and
the network node performs system recovery actions based on the calculated KPI measurements.

2. The apparatus of claim 1:
wherein the network node is an operations and maintenance center (OMC) further comprising a KPI recovery server (KRS) and a KPI compute server (KCS) where the KRS is communicatively coupled with the KCS;
further comprising a performance measurements (PM) data store that is communicatively coupled with the OMC, and the PM data store is communicatively coupled with the KCS;
wherein telecommunications network measurements received by the OMC are stored on the PM data store, and the KCS retrieves telecommunications network measurements from the PM data store and calculates KPI measurements based on the retrieved telecommunication network measurements;
wherein the KCS determines whether recovery actions should be performed based on the calculated KPI measurements, and communicates recovery actions to be performed to the KRS; and
the KRS performs the recovery actions.

3. The apparatus of claim 2, wherein determining whether recovery actions should be performed further comprises determining whether the calculated KPI measurement violates a KPI threshold; and
wherein a recovery action is associated with a KPI threshold and if the KPI threshold is violated the recovery action is executed.

4. The apparatus of claim 2, wherein performing recovery actions further comprises restarting at least one of a network process, a network element and a network subsystem.

5. The apparatus of claim 2, wherein the KPI measurements and the KPI thresholds are defined by a user, and the KCS is configured with the KPI measurements and KPI thresholds.

6. The apparatus of claim 2, wherein the KPI measurements comprises a subset of the telecommunications network measurements comprising the PM data store.

7. The apparatus of claim 2 wherein a KPI measurement is calculated from a plurality of telecommunication network measurements comprising the PM data store.

8. An apparatus, comprising:
a key performance indicator (KPI) compute server (KCS) that calculates KPI measurements based on telecommunications network measurements; and
wherein system recovery actions are performed based on the calculated KPI measurements.

9. The apparatus of claim 8:
further comprising a KPI recovery server (KRS) where the KCS is communicatively coupled with the KRS; and
the KCS determines if system recovery actions should be performed and communicates system recovery actions to the KRS and the KRS executes the system recovery actions wherein executing the system recovery actions comprises restarting at least one of a network process, a network element and a network subsystem.

10. The apparatus of claim 9 wherein the KCS determines if system recovery actions should be performed based on whether a KPI measurement violates a KPI threshold.

11. The apparatus of claim 10 wherein the KCS comprises a user interface that allows a user to configure the KCS with KPI thresholds and associated recovery actions.

12. The apparatus of claim 9, further comprising an OMC, a performance measurements (PM) data store and a PM data process, wherein the OMC is communicatively coupled with the PM data store via the PM data process, and the KCS is communicatively coupled with the PM data store; and
wherein the telecommunications network measurements are gathered by the OMC at regular intervals and communicated to the PM data store by the PM data process.

13. The apparatus of claim 12 wherein the KCS downloads from the PM data store telecommunications network measurements used to calculate KPI measurements to determine if system recovery actions should be performed, where system recovery actions are performed if a KCI measurement violates a KCI threshold.

14. The apparatus of claim 12 wherein the telecommunications network measurements used to calculate KPI measurements comprise a select subset of the telecommunications network measurements gathered by the OMC, wherein at least one of a system operator and an equipment vendor determines the KPI measurements.

15. A method comprising the steps of:
receiving telecommunications network measurements;
determining key performance indicator (KPI) measurements from the telecommunications network measurements; and
performing system recovery actions based on the calculated KPI measurements.

16. The method of claim 15 wherein the KPI measurements are determined from a select subset of the telecommunications network measurements.

17. The method of claim 16 further comprising the steps of:
comparing a KPI measurement with a KPI threshold;
determining a recovery action to execute if the KPI measurement violates the KPI threshold; and
executing the recovery action.

18. The method of claim 17 wherein executing the recovery action further comprises resetting at least one of a system component, a network element and a network subsystem.

19. The method of claim 17 wherein the KPI measurements are determined at regular intervals.

20. The method of claim 17 wherein a KPI compute server (KCS) is configured to determine the recovery actions and a KPI recovery server (KRS) is configured to perform the recovery action.
